(19) United States
(12) Patent Application Publication
(10) Pub. No.: US 2011/0025660 A1
(43) Pub. Date: Feb. 3, 2011

(54) Plasma display device

(76) Inventors: Yoojin Song, Suwon-si (KR); Kyongpil Jin, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 12/805,398

(22) Filed: Jul. 29, 2010

(30) Foreign Application Priority Data
Jul. 30, 2009 (KR) 10-2009-0069917

(51) Int. Cl. G09G 5/00; G09G 3/28

(52) U.S. Cl. 345/206; 345/60

(57) ABSTRACT

A plasma display device includes a plasma display panel including scan electrodes, a driver circuit portion including a connector, the driver circuit portion being configured to drive the plasma display panel, and a scan IC portion electrically connecting the plasma display panel to the driver circuit portion, the scan IC portion including a rigid substrate inserted in the connector, a scan IC on the rigid substrate, the scan IC being configured to receive an input signal and a reference potential from the driver circuit portion, and a flexible substrate electrically connected between the rigid substrate and the plasma display panel, the flexible substrate being configured to transmit an output signal from the scan IC to the scan electrodes.

### BACKGROUND

1. Field

Embodiments relate to a plasma display device.

2. Description of the Related Art

A plasma display device is a flat panel display device that employs plasma generated through gas discharge to display characters or images. A display panel of such a plasma display device has a plurality of address electrodes, scan electrodes, and sustain electrodes formed thereon, and discharge cells formed at junctions between the address electrodes, scan electrodes, and sustain electrodes.

In general, a frame in a plasma display panel of a plasma display device is divided into a plurality of subfields having respective weights, and each subfield includes a reset period, an address period, and a sustain period. A reset period is one in which a discharge cell is reset to perform stable address discharging. An address period is one in which cells of the plasma display panel are selected to be turned on (addressed cells) and not be turned on. A sustain period is one in which discharging of cells turned on is sustained to display an image.

A plasma display device employs a scan integrated circuit (IC) to apply data, i.e., a scan pulse, to scan electrodes to perform addressing in an address period. Unlike a general IC that uses ground (GND) as a reference potential, the reference potential of a scan IC is continuously variable in proportion to the voltage of a reset pulse applied to scan electrodes in a reset period and the voltage of a sustain pulse applied to the scan electrodes in a sustain period.

However, such a continuously variable reference potential of a conventional scan IC may cause increased noise generation in the sustain period because a sustain pulse with alternating high and low voltages is applied to the sustain electrodes, varying widely in the sustain period. This noise may cause malfunctioning and errors in the conventional scan IC. Further, a conventional scan IC may have a restricted input area of the reference potential, thereby reducing brightness uniformity.

### SUMMARY

Embodiments are therefore directed to a plasma display device, which substantially overcomes one or more of the problems due to the limitations and disadvantages of the related art.

It is therefore a feature of an embodiment to provide a plasma display device with a scan IC on a rigid substrate and a broad reference potential pattern for the scan IC in order to provide a stable reference potential via a broad input, thereby minimizing brightness variation.

It is another feature of an embodiment to provide a plasma display device with a scan IC mounted on a rigid substrate formed of an insulating material through fastening hooks of a connector formed with slots fastened to fastening holes formed in the rigid substrate, thereby eliminating a need for a separate insulating member and heat sink and reducing difficulties in assembling a separate insulating member and heat sink to the scan IC.

It is a further feature of an embodiment to provide a plasma display device with an input line pattern of a scan IC formed on a rigid substrate and an output line pattern of the scan IC formed on a flexible substrate, in order to reduce the amount of film that must be used to uniformly form input lines and output lines when a scan IC is mounted on film.

At least one of the above and other features and advantages may be realized by providing a plasma display device, including a plasma display panel having a scan electrode, a driver circuit portion including a connector installed thereon, the driver circuit portion driving the plasma display panel, and a scan IC portion electrically connecting the plasma display panel to the driver circuit portion, wherein the scan IC portion includes a rigid substrate inserted in the connector and including a scan IC mounted thereon, the scan IC receiving an input signal and a reference potential from the driver circuit portion, and a flexible substrate electrically connected between the rigid substrate and the plasma display panel, and transmitting an output signal from the scan IC to the scan electrode.

The rigid substrate may further include a fastening hole defined in both side ends thereof.

The connector may be formed as a slot type in which the rigid substrate is inserted, and may include a fastening hook formed on both side ends thereof to fasten with the fastening holes.

The fastening hook may be fastened through press-fitting in the fastening hole.

The rigid substrate may be formed as an insulating plate, and may further include a rigid input line pattern formed on an upper portion of the insulating plate and receiving the input signal, a rigid signal land connected to the rigid input line pattern, a rigid upper reference potential pattern formed around the rigid input line pattern and having the reference potential input thereto, a rigid lower reference potential pattern formed on a lower portion of the insulating plate, and a rigid reference potential via hole defined through the upper and lower portions of the insulating plate.

The rigid substrate may further include a rigid upper power pattern formed on the upper portion of the insulating plate and receiving power from the driver circuit portion, and a rigid lower power pattern formed on the lower portion of the insulating plate and receiving power from the driver circuit portion.

The rigid substrate may further include a rigid upper input terminal and a rigid lower input terminal formed on an end of the rigid upper and lower portion thereof, respectively, the rigid upper and lower input terminals inserting in the connector, the rigid upper input terminal may include a signal terminal connected to the rigid input line pattern, an upper reference potential terminal connected to the rigid upper reference potential pattern, and a rigid upper power terminal connected to the rigid upper power pattern, and the rigid lower input terminal may include a rigid lower reference potential terminal connected to the rigid lower reference potential pattern, and a rigid lower power terminal connected to the rigid lower power pattern.

The connector may further include a connector upper input terminal formed in a region thereof corresponding to the rigid upper input terminal, and a connector lower input terminal formed in a region thereof corresponding to the rigid lower input terminal.

The flexible substrate may be formed of a flexible film and include a flexible input line pattern formed in the flexible film, and to which the input signal is input, a flexible signal land connected to the flexible input line pattern, and including a signal via hole defined in a center thereof through an upper and lower portion of the flexible film, a flexible power pattern formed around the flexible input line pattern, and to which the power is input, a flexible output line pattern formed in the flexible film, and to which the output signal is output, a flexible reference potential pattern formed around the flexible output line pattern, and to which the reference potential is input, and a flexible reference potential via hole defined through the upper and lower portions of the flexible film.

The flexible substrate may further include a scan IC hole defined through the upper and lower portions of the flexible film, and into which the scan IC attached to the rigid substrate is inserted, and a dummy reference potential hole defined through the upper and lower portions of the flexible film around the scan IC hole.

The scan IC portion may include an overlapped region formed of the flexible substrate and the rigid substrate vertically overlapped, and a non overlapped region, the flexible reference potential via hole and the rigid reference potential via hole partially correspond vertically, the signal via hole and the rigid signal land vertically correspond, and the scan IC may insert in the scan IC hole.

The scan IC portion may further include a first reference potential via formed of a conductive material filled in the rigid reference potential via hole of the rigid substrate disposed in the non overlapped region, a second reference potential via formed of a conductive material filled in the flexible reference potential via hole of the flexible substrate and the rigid reference potential via hole of the rigid substrate that are disposed in the overlapped region, and a signal via formed of a conductive material filled in the signal via hole of the flexible substrate disposed in the overlapped region.

The scan IC may include a bonding pad, and the scan IC portion may further include a first conductive wire electrically connecting the bonding pad of the scan IC to the flexible input line pattern, a second conductive wire electrically connecting the bonding pad of the scan IC to the flexible reference potential pattern, a third conductive wire electrically connecting the bonding pad of the scan IC to the flexible power pattern, a fourth conductive wire electrically connecting the flexible reference potential pattern to the rigid upper reference potential pattern of the rigid substrate through the dummy reference potential hole, and a fifth conductive wire electrically connecting the bonding pad of the scan IC to the flexible output line pattern.

The driver circuit portion may be a scan driving board that generates a signal applied to the scan electrode.

### BRIEF DESCRIPTION OF THE DRAWINGS

The above and other features and advantages will become more apparent to those of ordinary skill in the art by describing in detail example embodiments with reference to the attached drawings, in which:

FIG. 1 illustrates a perspective view of a plasma display device according to an embodiment;

FIG. 2 illustrates an enlarged perspective view of region A in FIG. 1;

FIG. 3 illustrates a plan view of connectors and a scan IC portion in FIG. 2 before being connected according to an embodiment;

FIG. 4 illustrates a top plan view of a rigid substrate according to an embodiment;

FIG. 5 illustrates a bottom plan view of a rigid substrate according to an embodiment;

FIG. 6 illustrates a top plan view of a flexible substrate according to an embodiment;

FIG. 7 illustrates a plan view of a rigid substrate coupled to a flexible substrate according to an embodiment;

FIG. 8 illustrates an enlarged plan view of region C in FIG. 7; and

FIG. 9 illustrates a cross-sectional view taken along line B-B′ in FIG. 2.

### DETAILED DESCRIPTION

Korean Patent Application No. 10-2009-0069917, filed on Jul. 30, 2009, in the Korean Intellectual Property Office, and entitled: “Plasma Display Device,” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

In the drawing figures, the dimensions of elements and regions may be exaggerated for clarity of illustration. It will also be understood that when a layer or element is referred to as being “on” another element or substrate, it can be directly on the other element or substrate, or intervening elements may also be present. In addition, it will also be understood that when an element is referred to as being “between” two elements, it can be the only element between the two elements, or one or more intervening elements may also be present. Further, when an element is “connected” to another element, they can be “directly connected” to each other, “indirectly connected” to each other, or “electrically connected” to each other with or without another element interposed therebetween. Like reference numerals refer to like elements throughout.

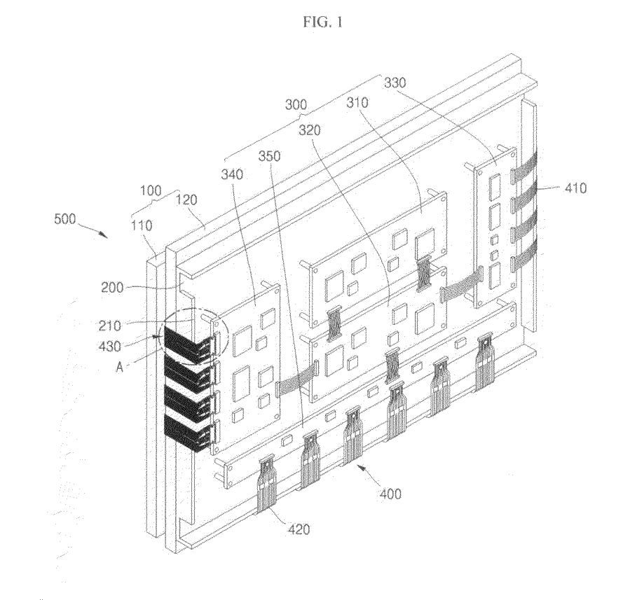

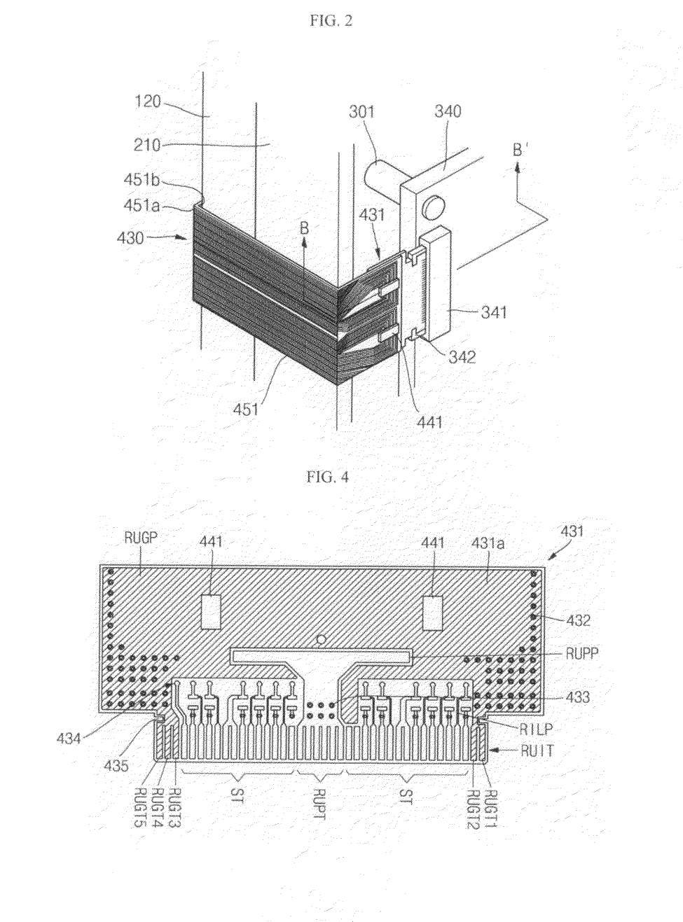

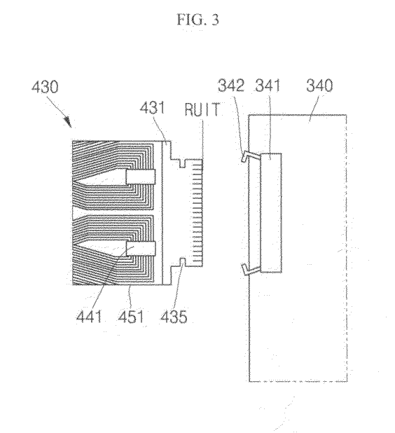

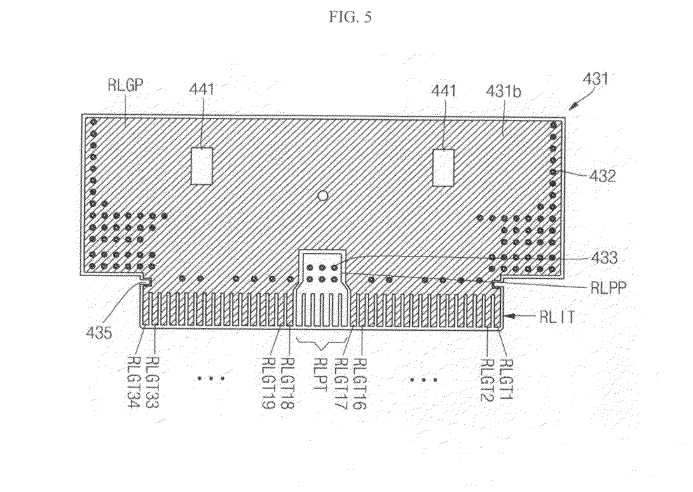

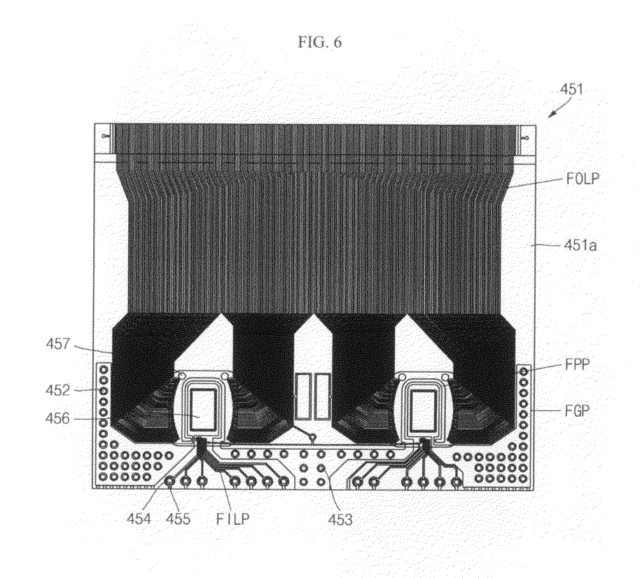

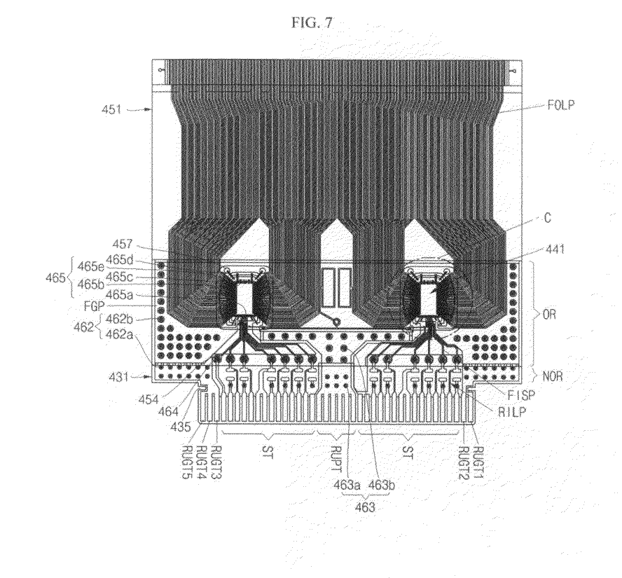

FIG. 1 illustrates a perspective view of a plasma display device according to an embodiment, FIG. 2 illustrates an enlarged perspective view of region A in FIG. 1, FIG. 3 illustrates a plan view of connectors and a scan IC portion in FIG. 2 before being connected according to an embodiment, FIG. 4 illustrates a top plan view of a rigid substrate according to an embodiment, FIG. 5 illustrates a bottom plan view of a rigid substrate according to an embodiment, and FIG. 6 illustrates a top plan view of a flexible substrate according to an embodiment.

As illustrated in FIGS. 1 and 2, a plasma display device 500 according to an embodiment may include a plasma display panel 100, a chassis base 200, a driver circuit 300, and a signal transmitting member 400.

The plasma display panel 100 may include a front panel 110 and a rear panel 120, and may display characters and/or images through gas discharge. The plasma display panel 100 is divided into a plurality of subfields having respective weights and driven, and each subfield may include a reset period, an address period, and a sustain period. A reset period is one in which a discharge cell is reset to perform stable address discharging. An address period is one in which cells of the plasma display panel 100 are selected to be turned on (addressed cells) and not be turned on. A sustain period is one in which discharging of cells turned on is sustained to display an image.

The front panel 110 of the plasma display panel 100 may be formed to include scan electrodes and sustain electrodes that are configured to run horizontally straight and parallel to one another, and the rear panel 120 of the plasma display panel 100 may be formed to include address electrodes that are configured to run vertically straight and parallel to one another. Barrier walls, electrodes, phosphor, dielectrics, protective layers, etc. (not shown) may be formed between the front panel 110 and rear panel 120 to define spaces, i.e., discharge cells, in which discharging occurs. The discharge cells may be filled with an inert gas that emits ultraviolet rays in the wavelength band that excites phosphor during discharge. The plasma display panel 100 may be connected to the driver circuit 300 through the signal transmitting member 400.

The chassis base 200 may be installed on the rear panel 120, e.g., a front surface of the chassis base 200 may face away from a rear surface of the front panel 110, and may function to support the plasma display panel 100 and receive and dissipate heat generated by the plasma display panel 100. The chassis base 200 may be formed of a metal material, e.g., aluminum, having high thermal conductivity. It should be noted, however, that the chassis base 200 is not limited to any one material. For reinforcing strength, the chassis base 200 may further include bent portions 210 that extend rearward from the edges of the chassis base 200. While not illustrated, an adhesive member and a heat sink may be interposed between the plasma display panel 100 and the chassis base 200. It is noted that, in embodiments, the term “front surface” denotes a surface facing the front panel 110, and the term “rear surface denotes a surface facing away from the front panel 110 of the plasma display panel 100.

The driver circuit 300 may be disposed on a rear surface of the rear panel 120, e.g., on the rear surface of the chassis base 200, via a boss 301. The driver circuit 300 may be divided into a plurality of driving boards 310, 320, 330, 340, and 350 to drive the plasma display panel 100. For example, the driver circuit 300 may include a switch mode power supply (SMPS) 310, a logic board 320, a sustain driving board 330, a scan driving board 340, and an address driving board 350. Each of the driving boards 310, 320, 330, 340, and 350 may have a driver chip and other circuit devices installed thereon that are required to drive the plasma display panel 100.

As a component for supplying electrical power to the driver circuit 300 and plasma display panel 100, the SMPS 310 may include an AC/DC converter mounted thereon that converts alternating current supplied from an external source into direct current. The logic board 320 may receive an image signal, may separate and control the received image signal to be input to the sustain driving board 330, the scan driving board 340, and the address driving board 350, and may automatically adjust electrical power. The sustain driving board 330, scan driving board 340, and address driving board 350 may receive respective signals from the logic board 320, may generate signals to be applied to a sustain electrode, a scan electrode, and an address electrode, respectively, and may allocate the signals to the respective electrodes. It is noted that the scan driving board 340 may be attached, e.g., directly, to the chassis base 200 via bosses 301 without a scan buffer board for buffering a signal transmitted between the scan driving board 340 and the plasma display panel 100.

The signal transmitting member 400 may electrically connect the sustain driving board 330, the scan driving board 340, and the address driving board 350 to the plasma display panel 100, respectively, and may transmit drive signals from the sustain driving board 330, the scan driving board 340, and the address driving board 350 to the plasma display panel 100, respectively. The signal transmitting member 400 may be divided into a sustain electrode signal transmitting member 410, an address electrode signal transmitting member 420, and a scan electrode signal transmitting member (or a scan IC portion) 430. In embodiments, detailed description will be provided of a scan IC portion 430 used as a signal transmitting member connected between the plasma display panel 100 and the scan driving board 340.

As illustrated in FIG. 1, the scan IC portion 430 may have a first end connected to a scan electrode (not illustrated) of the plasma display panel 100 and a second end connected to a connector 341 (FIG. 2) of the scan driving board 340, and may be disposed across the bent portion 210 of the chassis base 200. The scan IC portion 430 may be formed as a chip-on-board (COB) type.

As illustrated in FIGS. 2 and 3, the scan IC portion 430 may include a rigid substrate 431, a scan IC 441, and a flexible substrate 451. The scan IC portion 430 may transmit signals from the scan driving board 340 through the connector 341, rigid substrate 431, scan IC 441, and flexible substrate 451 to the scan electrode of the plasma display panel 100.

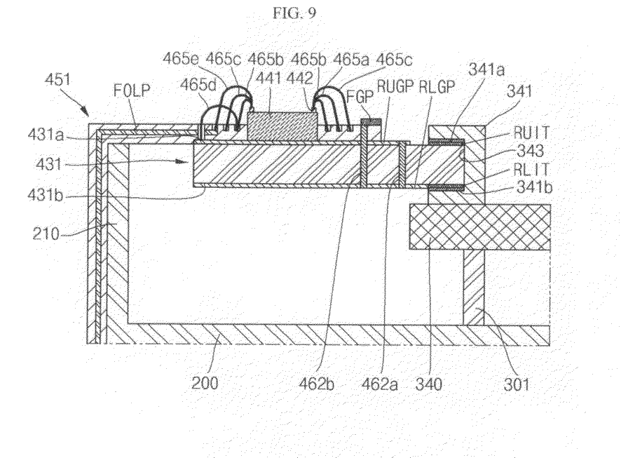

In further detail, the rigid substrate 431 may be a rigid plate formed as an insulating plate, and may be attached, e.g., directly, to the connector 341 of the scan driving board 340. For example, as illustrated in FIGS. 2 and 3, the connector 341 may be positioned on the scan driving board 340, so the rigid substrate 431 may be inserted into a slot 343 (FIG. 9) of the connector 341. The connection between the rigid substrate 431 and the connector 341 will be described in more detail below with reference to FIGS. 2-5.

The rigid substrate 431, as illustrated in FIG. 4, may include a rigid input line pattern (RILP) formed on a top surface 431a thereof, i.e., on a top surface of the insulating plate, and may receive input signals, e.g., a scan IC control signal, a scan high signal, etc., from the scan driving board 340 through the RILP. Also, the rigid substrate 431 may include a rigid upper power pattern (RUPP) formed in a center portion of the top surface 431a of the rigid substrate 431, and may receive power from the scan driving board 340 through the RUPP. The rigid substrate 431 may further include a rigid upper ground pattern (RUGP) formed around the RILP, and may receive a reference potential of the scan driving board 340 through the RUGP. Here, the reference potential is one that continuously varies in relation to the voltage of a reset pulse applied to the scan electrode during the reset period and the voltage of a sustain pulse applied to the scan electrode during the sustain period, and may be a voltage ranging from a voltage of a scan low signal, e.g., about (−190) V, to a voltage of a reset pulse applied to the scan electrode, e.g., about 200 V.

In addition, the rigid substrate 431, as illustrated in FIG. 5, may include a rigid lower ground pattern (RLGP) formed entirely on a bottom surface 431b, i.e., a surface opposite the top surface 431a, of the rigid substrate 431, and may receive a reference potential of the scan driving board 340 through the RLGP. Also, the rigid substrate 431 may include a rigid lower power pattern (RLPP) formed on the bottom surface 431b of the rigid substrate 431, and may receive power from the scan driving board 340 through the RLPP. For example, the RLPP may be aligned with the RUPP.

The rigid substrate 431, as illustrated in FIGS. 4 and 5, may include a rigid reference potential via hole 432 extending through the rigid substrate 431, i.e., between the top and bottom surfaces 431a and 431b of the rigid substrate 431. A conductive material may be filled in the rigid reference potential via hole 432 to electrically connect the RUGP to the RLGP. Thus, the rigid substrate 431 may secure a broad reference potential pattern, i.e., the RUGP and RLGP, electrically connected from the top to the bottom of the rigid substrate 431.

The rigid substrate 431 may additionally include a rigid power via hole 433 defined from the top to the bottom of the plate. A conductive material may be filled in the rigid power via hole 433 to electrically connect the RUPP to the RLPP.

The rigid substrate 431 may include a rigid upper input terminal (RUIT) and a rigid lower input terminal (RLIT) formed on top and bottom surfaces 431a and 431b of the rigid substrate 431, respectively. The RUIT and RLIT may be formed at the edge of the rigid substrate 431, and may be connected to the connector 341. For example, the connector 341 may have a slot shape, so a front portion of the rigid substrate 431, i.e., a portion including the RUIT and the RLIT, may be inserted into the slot 343 (FIG. 9) to be coupled to the connector 341. For example, the RUIT may be aligned with respective RLIT.

The RUIT of the rigid substrate 431 may include a signal terminal (ST) connected to the RILP, a rigid upper power terminal (RUPT) connected with the RUPP, and rigid upper ground terminals (RUGTs) 1 to 5 connected to the RUGP. The RUIT may contact a connector upper input terminal 341a formed within a connector 341, as illustrated in FIG. 9. The RLIT may include rigid lower ground terminals (RLGTs) 1 to 34 connected to the RLGP, and a rigid lower power terminal (RLPT) connected to the RLPP. The RLIT may contact a connector lower input terminal 341b formed within a connector 341, as illustrated in FIG. 9.

Also, as illustrated in FIG. 4, the rigid substrate 431 may include a rigid signal land 434 formed on one of the ends of the RILP, i.e., an end not connected to the RUIT. The rigid signal land 434 may be electrically connected to a flexible signal land 454 (FIG. 6) through a signal via 464 (FIG. 7) that fills a signal via hole 455 of the flexible substrate 451 (FIG. 6).

As illustrated in FIGS. 2-5, the rigid substrate 431 may include fastening holes 435 in both side ends along a lengthwise direction thereof. For example, the fastening holes 435 may extend from an edge of the rigid substrate 431 in a direction substantially perpendicular to a direction of the RUIT and RLIT. The fastening holes 435 may be formed to physically couple to the connector 341 of the scan driving board 340 to the rigid substrate 431. In other words, as illustrated in FIGS. 2 and 3, the connector 341 may include fastening hooks 342, e.g., L-shaped clasps, adapted to fit into the fastening holes 435 when the rigid substrate 431 is inserted into the connector 341 and to prevent movement of the rigid substrate 431. By fitting the fastening holes 435 and the fastening hooks 342, coupling of the rigid substrate 431 and the connector 341 may be firmly and easily achieved. Here, the fastening hooks 342 may be press-fitted to prevent or substantially minimize disengagement of the fastening hooks 342 from the fastening holes 435 when the connector and the rigid substrate 431 are connected to each other. The fastening hooks 342 may be removable.

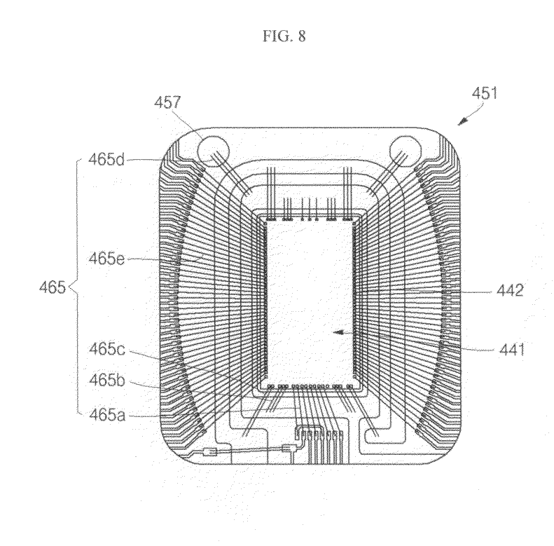

The scan IC 441 of the scan IC portion 430 may be mounted in plurality on the rigid substrate 431, e.g., on the upper surface of the rigid substrate 431 via an adhesive member (not illustrated), and a bonding pad 442 (in FIG. 8) of the scan IC 441 may be electrically connected to the RILP and the RUGP and RLGP of the rigid substrate 431.

Accordingly, the scan IC 441 may receive an input signal and reference potential from the scan driving board 340 through the RILP and RUGP and RLGP of the rigid substrate 431. Also, the bonding pad 442 (in FIG. 8) of the scan IC 441 may be electrically connected to a flexible output line pattern (FOLP) of the flexible substrate 451, e.g., through wire bonding, etc, as will be discussed in more detail below. Therefore, the scan IC 441 may transmit an output signal to a scan electrode of the plasma display panel 100 through the FOLP of the flexible substrate 451.

Referring to FIG. 6, the flexible substrate 451 of the scan IC portion 430 may be formed of a flexible film having a length that connects the rigid substrate 431 and the scan electrode of the plasma display panel 100. The flexible substrate 451 may include a flexible input line pattern (FILP) formed at an end of the flexible film, and may transmit an input signal of the scan driving board 340 through the FILP. In other words, an input signal may be transmitted from the scan driving board 340 through the RILP of the rigid substrate 431, the scan IC 441, and the FILP to the flexible substrate 451. The flexible substrate 451 may also include a flexible power pattern (FPP) formed around the FILP in the flexible film, and may receive power from the scan driving board 340 transmitted through the RUPP and RLPP of the rigid substrate 431 through the FPP.

The flexible substrate 451 may further include the FOLP in the flexible film, and may transmit an output signal of the scan IC 441 to the scan electrode of the plasma display panel 100 through the FOLP. The flexible substrate 451 may additionally include a flexible ground pattern (FGP) formed around the FOLP in the flexible film, and may apply a reference potential of the scan driving board 340 applied through the RUGP and RLGP of the rigid substrate 431 to the scan IC 441 through the FGP.

The flexible substrate 451 may also include a flexible reference potential via hole 452 formed therethrough, i.e., a via hole extending between the top and bottom surfaces 451a and 451b of the flexible film, and the flexible reference potential via hole 452 may be filled with a conductive material. The flexible substrate 451 may further include a flexible power via hole 453 formed therethrough, i.e., a via hole extending between the top and bottom surfaces 451a and 451b of the flexible film, and the flexible power via hole 453 may be filled with a conductive material. The flexible substrate 451 may additionally include the flexible signal land 454 formed in a region corresponding to the rigid signal land 434 of the rigid substrate 431. Therefore, when the flexible substrate 451 is partially coupled to the rigid substrate 431 in a vertically overlapping manner, e.g., through heat pressing or an adhesive member (not illustrated), the flexible signal land 454 and the rigid signal land 434 may be aligned, i.e., overlap each other. The signal via hole 455 may be formed from the top surface 451a to the bottom surface 451b of the flexible film at a center of the flexible signal land 454, and the signal via hole 455 may be filled with conductive material.

The flexible substrate 451 may also include a scan IC hole 456 in which the scan IC 441 attached to the rigid substrate 431 may be inserted, when the flexible substrate 451 is partially coupled to the rigid substrate 431 in a vertically overlapping manner through heat pressing or an adhesive member (not illustrated). The flexible substrate 451 may further include a dummy reference potential hole 457 formed around the scan IC hole 456.

Coupling of the flexible substrate 451 and the rigid substrate 431 to which the scan IC 441 is attached may be performed by partially overlapping the substrates vertically through heat pressing or an adhesive member (not illustrated). For example, a portion of the rigid substrate 431 that includes the scan IC 441 may overlap a portion of the flexible substrate 451, so some of the flexible reference potential via hole 452 of the flexible substrate 451 may be vertically aligned with, i.e., overlap, corresponding rigid reference potential via hole 432 of the rigid substrate 431. Also, when the rigid substrate 431 and the flexible substrate 451 are coupled, the signal via hole 455 and the rigid signal land 434 may be vertically aligned, i.e., correspond to each other, and the scan IC 441 may be inserted in the scan IC hole 456 of the flexible substrate 451. It is noted that when the rigid substrate 431 and the flexible substrate 451 are coupled, the FOLP of the flexible substrate 451 and the RLIT/RUIT of the rigid substrate 431 extend in opposite directions.

Next, an electrical connection of the rigid substrate 431, scan IC 441, and flexible substrate 451 coupled as described above will be described in detail with reference to FIGS. 7 to 9. FIG. 7 illustrates a plan diagram of the rigid substrate 431 coupled to the flexible substrate 451 according to embodiments, FIG. 8 illustrates an enlarged plan diagram of region C in FIG. 7, and FIG. 9 illustrates a cross-sectional view along line B-B′ in FIG. 2. In order to illustrate the electrical connections between the rigid substrate 431, the scan IC 441, and the flexible substrate 451, FIGS. 7 and 8 illustrate exposed signal patterns of the flexible substrate 451, and FIGS. 9-9 illustrate states before the scan IC 441 and conductive wire 465 are covered with a resin.

Referring to FIGS. 7 to 9, the scan IC portion 430 may have an overlapped region (OR) in which the flexible substrate 451 may be coupled over the rigid substrate 431, and a non overlapped region (NOR). For example, the NOR may be a portion of the rigid substrate 431 that is adjacent to the RILP and does not overlap the flexible substrate 451. The scan IC portion 430 may include a reference potential via 462, power via 463, signal via 464, and conductive wire 465, for electrical connections between the rigid substrate 431, scan IC 441, and flexible substrate 451.

The reference potential via 462 may include a first reference potential via 462a and a second reference potential via 462b. The first reference potential via 462a may be formed with conductive material filling the rigid reference potential via hole 432 of the rigid substrate 431 disposed in the NOR. The first reference potential via 462a may electrically connect the RUGP and RLGP of the rigid substrate 431. The conductive material in the second reference potential via 462b may be formed with conductive material filling the flexible reference potential via hole 452 of the flexible substrate 451 and the rigid reference potential via hole 432 of the rigid substrate 431 disposed in the OR where the rigid substrate 431 and flexible substrate 451 overlap. The conductive material in the second reference potential via 462b may electrically connect the FGP of the flexible substrate 451 and the RUGP and RLGP of the rigid substrate 431.

The power via 463 may include a first power via 463a and a second power via 463b. The first power via 463a may be formed with conductive material filling the rigid power via hole 433 of the rigid substrate 431 disposed in the NOR, and may electrically connect the RUPP and RLPP of the rigid substrate 431. The second power via 463b may be formed with conductive material filling the flexible power via hole 453 of the flexible substrate 451 and rigid power via hole 433 of the rigid substrate 431 disposed in the OR where the rigid substrate 431 and the flexible substrate 451 overlap, and may electrically connect the FPP of the flexible substrate 451 and the RUPP and RLPP of the rigid substrate 431.

The signal via 464 may be formed with conductive material filling the signal via hole 455 of the flexible substrate 451 disposed in the OR where the rigid substrate 431 and the flexible substrate 451 overlap. The conductive material in the signal via 464 may be electrically connected to the rigid signal land 434, and may electrically connect the FILP and the RILP.

The conductive wire 465 may include a first conductive wire 465a, a second conductive wire 465b, a third conductive wire 465c, a fourth conductive wire 465d, and a fifth conductive wire 465e. The first conductive wire 465a may electrically connect the bonding pad 442 of the scan IC 441 and the FILP, and may provide a route for transmitting an input signal from the scan driving board 340 input through the FILP to the scan IC 441. The second conductive wire 465b may electrically connect the bonding pad 442 of the scan IC 441 and the FGP, and may provide a route for transmitting a reference potential of the scan driving board 340 applied through the FGP to the scan IC 441.

The third conductive wire 465c may electrically connect the bonding pad 442 of the scan IC 441 and the FPP, and may provide a route for applying power from the scan driving board 340 to the flexible substrate 451 and the rigid substrate 431 through the FPP and the rigid power patterns RUPP and RLPP. The fourth conductive wire 465d may electrically connect the FGP and RUGP of the rigid substrate 431 through the dummy reference potential hole 457, and may provide a route for transmitting a reference potential of the scan driving board 340 to the scan IC 441 through the RUGP of the rigid substrate 431 and the FGP. The fifth conductive wire 465e may electrically connect the bonding pad 442 of the scan IC 441 and the FOLP, and may provide a route for transmitting an output signal from the scan IC 441 to a scan electrode of the plasma display panel 100.

As described above, the plasma display device 500 according to embodiments may stably apply a reference potential to the scan IC 441 by securing a broad reference potential pattern RUGP and RLGP for a scan IC 411 mounted on a rigid substrate 431. In contrast, when a conventional scan IC is mounted on a film, i.e., on a non-rigid surface, a scan IC may be designed in blocks, e.g., have a configuration of a chip-on-film (COF) in an effort to reduce costs, having a predetermined number in order to reduce the amount of film used. As such, an input area of the conventional scan IC to which the reference potential is applied may be limited, thereby causing brightness variations by block. Therefore, implementation of the broad reference potential pattern RUGP and RLGP for the scan IC 411 on the rigid substrate 431 according to example embodiments may improve picture quality, e.g., increased brightness uniformity, in the plasma display device 500.

Also, since the plasma display device 500 may include the scan IC 441 on the rigid substrate 431, which may be formed of an insulating material and may include fastening holes 435 connected to a connector 341 through the fastening hooks 342, the rigid substrate may function as an insulator and as a heat sink, thereby reducing noise and dissipating heat. In other words, a need for a separate insulating member, e.g., a separate scan buffer board, in the plasma display device 500 may be eliminated, e.g., as compared to a conventional scan IC on film, thereby avoiding difficulties in assembling a separate insulating member and heat sink to a scan IC. Therefore, the plasma display device 500 may have reduced manufacturing costs, e.g., reduced costs incurred due to provision of an insulating member and a heat sink. Further, mounting and assembly of the scan IC may be simplified because a need for a heat sink, i.e., for dissipating heat from the scan IC, insulated from the scan driver board and the may be eliminated.

Further, the plasma display device 500 according to embodiments may have an input line pattern of the scan IC 441 on the rigid substrate 431 and an output line pattern of the scan IC 441 on the flexible substrate 451, so an amount of film used to uniformly form input lines and output lines may be reduced, e.g., as compared to a conventional scan IC on a film. Therefore, the plasma display device 500 may have reduced overall manufacturing costs.

Exemplary embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A plasma display device, comprising:
a plasma display panel including scan electrodes;
a driver circuit portion including a connector, the driver circuit portion being configured to drive the plasma display panel; and
a scan integrated circuit (IC) portion electrically connecting the plasma display panel to the driver circuit portion, the scan IC portion including:
a rigid substrate connected to the connector,
a scan IC on the rigid substrate, the scan IC being configured to receive an input signal and a reference potential from the driver circuit portion, and
a flexible substrate connected between the rigid substrate and the plasma display panel, the flexible substrate being configured to transmit an output signal from the scan IC to the scan electrodes.

2. The plasma display device as claimed in claim 1, wherein the rigid substrate includes a fastening hole at side ends thereof.

3. The plasma display device as claimed in claim 2, wherein the connector includes a slot and fastening hooks, the rigid substrate being configured to fit in the slot, and the fastening hooks being configured to fasten with the fastening holes of the rigid substrate.

4. The plasma display device as claimed in claim 3, wherein the fastening hooks are press-fitted in the fastening hole.

5. The plasma display device as claimed in claim 1, wherein the rigid substrate is an insulating plate, the rigid substrate including:
a rigid input line pattern on a top surface of the insulating plate and configured to receive the input signal;
a rigid signal land connected to the rigid input line pattern;
a rigid upper reference potential pattern around the rigid input line pattern and having the reference potential input thereto;
a rigid lower reference potential pattern on a bottom surface of the insulating plate; and
a rigid reference potential via hole extending between the top and bottom surfaces of the insulating plate.

6. The plasma display device as claimed in claim 5, wherein the rigid substrate further comprises:
a rigid upper power pattern on the top surface of the insulating plate and configured to receive power from the driver circuit portion; and
a rigid lower power pattern on the bottom surface of the insulating plate and configured to receive power from the driver circuit portion.

7. The plasma display device as claimed in claim 6, wherein the rigid substrate further comprises a rigid upper input terminal and a rigid lower input terminal on respective top and bottom surfaces of the rigid substrate, the rigid upper and lower input terminals being inserted into the connector,
wherein the rigid upper input terminal includes:
a signal terminal connected to the rigid input line pattern,
a rigid upper reference potential terminal connected to the rigid upper reference potential pattern, and
a rigid upper power terminal connected to the rigid upper power pattern, and
wherein the rigid lower input terminal includes:
a rigid lower reference potential terminal connected to the rigid lower reference potential pattern, and
a rigid lower power terminal connected to the rigid lower power pattern.

8. The plasma display device as claimed in claim 7, wherein the connector includes:
a connector upper input terminal in a region corresponding to the rigid upper input terminal; and
a connector lower input terminal in a region corresponding to the rigid lower input terminal.

9. The plasma display device as claimed in claim 6, wherein the flexible substrate is a flexible film, the flexible substrate including:
a flexible input line pattern in the flexible film, and to which the input signal is input;
a flexible signal land connected to the flexible input line pattern, and including a signal via hole extending in a center thereof between top and bottom surfaces of the flexible film;
a flexible power pattern around the flexible input line pattern, and to which the power is input;
a flexible output line pattern in the flexible film, and to which the output signal is output;
a flexible reference potential pattern around the flexible output line pattern, and to which the reference potential is input; and
a flexible reference potential via hole extending between the top and bottom surfaces of the flexible film.

10. The plasma display device as claimed in claim 9, wherein the flexible substrate further comprises:
a scan IC hole extending between the top and bottom surfaces of the flexible film, the scan IC on the rigid substrate being inserted in the scan IC hole; and
a dummy reference potential hole extending between the top and bottom surfaces of the flexible film and around the scan IC hole.

11. The plasma display device as claimed in claim 10, wherein:
the scan IC portion includes an overlapping region and a non-overlapping region, the overlapping region includes vertically overlapping portions of the flexible substrate and the rigid substrate;
the flexible reference potential via hole and the rigid reference potential via hole are at least partially correspond to each other along a vertical direction;
the signal via hole and the rigid signal land vertically correspond to each other; and
the scan IC is inserted in the scan IC hole.

12. The plasma display device as claimed in claim 11, wherein the scan IC portion further comprises:
a first reference potential via, the first reference potential via including a conductive material in the rigid reference potential via hole of the rigid substrate disposed in the non-overlapping region;
a second reference potential via, the second reference potential via including a conductive material in the flexible reference potential via hole of the flexible substrate and in the rigid reference potential via hole of the rigid substrate that are disposed in the overlapping region; and
a signal via including a conductive material in the signal via hole of the flexible substrate disposed in the overlapping region.

13. The plasma display device as claimed in claim 12, wherein the scan IC includes a bonding pad, the scan IC portion further comprises:
a first conductive wire electrically connecting the bonding pad of the scan IC to the flexible input line pattern;
a second conductive wire electrically connecting the bonding pad of the scan IC to the flexible reference potential pattern;
a third conductive wire electrically connecting the bonding pad of the scan IC to the flexible power pattern;
a fourth conductive wire electrically connecting the flexible reference potential pattern to the rigid upper reference potential pattern of the rigid substrate through the dummy reference potential hole; and
a fifth conductive wire electrically connecting the bonding pad of the scan IC to the flexible output line pattern.

14. The plasma display device as claimed in claim 1, wherein the driver circuit portion is a scan driving board that generates a signal applied to the scan electrode.
